(19) United States
(12) Patent Application Publication
(10) Pub. No.: US 2025/0034055 A1
(43) Pub. Date: Jan. 30, 2025

(54) Replenished Earth Carbon capture catalyst and economic system for beneficial use on a massive scale

(71) Applicant: Farley Merril Anderson, Paradise, UT (US)

(72) Inventor: Farley Merril Anderson, Paradise, UT (US)

(21) Appl. No.: 18/226,170

(22) Filed: Jul. 25, 2023

(51) Int. Cl. C05F 5/00; B09B 3/25; B09B 101/70; C05F 17/10

(52) U.S. Cl. CPC C05F 5/002; B09B 3/25; C05F 17/10; B09B 2101/70

(57) ABSTRACT

A safe, odorless system to capture food waste in a base of sodium reduced and concentrated sea minerals held for beneficial reuse that becomes a catalyst for enhanced carbon capture while increasing the value of this waste towards this objective. This invention enables recapture of waste on a massive scale. This system may invigorate our agricultural economy and impact climate change. This is connected to part two of this patent, Part two—Customization of the catalyst for maximum carbon capture and to Part Three of this patent, Part Three—an economic method to use and maximize use of the carbon capture properties on a massive scale.

This application claims priority on U.S. Provisional application No. 63/369,271 filed on Jul. 25, 2022. All documents above are herein incorporated by reference.

### FIELD OF INVENTION

Carbon Capture, Food waste recycling, Agriculture, Economic and farm sustainability.

### INVENTION OVERVIEW

My invention is for the capture and sequestering of Carbon in Agricultural soils and is a new method to capture food waste for beneficial reuse. This method is based on a new use for concentrated liquid sodium-removed sea mineral concentrates. (Note: these sea minerals may be from inland seas such as the Great Salt Lake, the Dead Sea, or underground seas such as are commonly found in deep wells in addition to regular sea water concentrates). Arguably, the most promising area that has the potential of sequestering the massive amounts of Carbon needed to offset the use of carbon based fuels is found in looking towards the soil. Scientists have proposed various models where soil enhancement can sequester the amounts of carbon an industrialized world creates. The upside of my invention is that it becomes far more affordable and doable now and requires far less resources. Starting with capturing a massive amount of waste stream carbon via food waste and especially using this system's proposed ability to tap into early funding this system makes it possible for massive amounts of carbon to be captured.

The concentrated, sodium-removed sea minerals are used to render the food waste/carbohydrate mixture bacteriologically inert, thus making the mixture safer, more odor-free and more stable in storage and transport and creates a more valuable end use product. This is the beginning usage of the invention. My proposed beneficial end-use makes this gathering process more valuable and thus the system is more economical. Carbohydrates, fiber, and other caloric food waste, when combined with these concentrated, sodium-removed sea minerals, complement each other, forming valuable and beneficial end-uses superior to the value of the components individually or separately. These new uses include a direct soil enhancement as an addition to soil, a composting aid, and for use as part of a proposed system and catalyst to capture carbon more effectively in soil on a large scale. This patent is important because it opens the door for millions of tons of waste food to be recycled in a way that may help revitalize the agricultural sector economically, all while having a very positive environmental impact and carbon sequestering effect. Part of this invention is the business model proposed. These new uses have broad applications.

### The Problem

Odor and sanitation problems associated with food waste are a reason why much of this waste is simply mixed with water and disposed of in water waste streams where it contributes to pollution or is put in the trash where it remains a health hazard and wastefully contributes to landfill and disposal problems, while still contributing negatively to air quality, vermin and odor problems in waste management. These discarded nutrients are major pollution and refuse problems in one sense but they can become a major benefit when used according to this patent for later direct application to soil, and or in composting, and or as part of large-scale carbon-capturing systems. My invention is an eloquent solution to overcoming the smell, vermin, health hazards and storage of food waste while making the removal and use of this waste a private sector priority through the creation of more valuable end-use products.

### Verification

When I first invented this new use I hastily made a mix of the catalyst with an equal amount of high carbohydrate kitchen and table waste. After several weeks of no odor I filed the provisional patent incorporating this new use with what is now incorporated as part two of this patent. After a full year of storage it is noted that the mix never had, nor now has, a foul smell and the not unpleasant earthy smell can only be detected when putting your nose inches away from the bucket. The lack of any rotting smell is indicative of its ability to curb spoilage and this alone overcomes one of the main issues associated with saving this carbon. In some third world areas whole populations live under the constant stress of the smell of rotting and wasted food carbon.

### Previous Systems, Problems and Desired Outcomes

Most large-scale capture and use systems for food waste as a valuable resource have previously relied heavily on government systems and taxpayer subsidies. While this is one answer, there are many benefits to private and voluntary systems. The creation of greater value and then a system to properly promote and support this could put into place great benefits to society without the burden on the taxpayers. In California, a new January 2022 law requires all businesses and private residences to separate and turn in compostable food waste. One of the main criticisms of this mandated system is that although much more compost is expected to be generated, the fear is that it may be less available to farmers who could best use it to increase soil fertility and to effectively combat global warming through soil carbon capture. By beginning with the end in mind of creating a system to get the resource to where it could do the highest good, and potentially doing it through a private, non-government system where more focused outcomes and adaptability are used in the creation of value, then potentially the best good may be achieved. This patent proposed system enables the private sector to do work usually and previously only attempted by governments on a large scale.

### Historical Background

I have worked for many years on perfecting a system to increase the vitality of soil using sea minerals to replenish the earth (see my book Nature's Answer, Replenish the earth, by Farley Anderson copyright 1995 to present). A major breakthrough for this invention came because of rethinking my own research as it could apply to the challenge of carbon capture. I began working on the specific problem of carbon capture and how the minerals I was working with could possibly contribute to carbon capture on a large scale. This led to the discoveries that led to the invention of the carbon capture catalyst and the methods covered in Part two of this patent (see part two). These carbon capture methods use as their foundation a customizable carbon capture catalyst based upon the concentrated sodium-removed sea minerals that are increased in activity and customized for different soil types by the addition of carbohydrates. The carbohydrates seem to have the function of providing the bio-feedstock for the bacteria that are enabled to work better and hold the minerals in place in the presence of the sea mineral concentrate as a catalyst for intensified carbon capture. This mixture of the sodium-removed sea mineral concentrates with a customized carbohydrate base is the carbon capture catalyst. This catalyst enhances active carbon capture in the soil and is the foundation of an economic machine described in this patent. The side benefit is that this work to capture atmospheric carbon also increases soil fertility. The need for carbohydrates to increase function as well as a desire to do the most good stimulated me to ponder, and then I invented this complementary additional system and new use that became part one of this patent. This proposed new use is a stand-alone system as well as now able to be incorporated with the second part of this patent.

### INVENTION DESCRIPTION

A waste-food, caloric and/or carbohydrate source, is drenched, submerged, coated or mixed with concentrated all natural, sodium-removed, sea mineral, liquid concentrate brine. In this state the mixture becomes more bacteriologically stable, odor reduced, and vermin repulsive as a food source and is far safer to handle than the waste refuse alone. Unlike fresh waste which becomes increasingly odorous and unsafe, this mix can flexibly be held on-site or at a facility for even very long periods of time without the problems associated with rotting refuse. This allows other and later beneficial aspects to be put in place to maximize reuse benefit. More waste may now be recycled because of more flexible circumstances. This requires less care and reduces the expense of rapid transport and processing currently required in dealing with fresh waste refuse. The increased value of the end product created holds the ultimate costs of disposal down.

### Further Description Details

The mixture may be ground to facilitate uniformity and ease of handling. Differing amounts of the sodium-removed sea mineral concentrate brine may be required to effectively stabilize different types of waste food. Other adaptations may also be desirable. The amount of the concentrated sodium-removed sea mineral brine needed to render the mixture inert will usually range from 20 to 50 percent of the total mass. The grinding step is not necessary for function but would facilitate pumpability, uniformity, and handling ease. Before end-use application to soil or use as a composting aid or in use in the patent system, this mixture is diluted, usually with water. This undoes the effect of the inhibited bacteria growth the concentrated minerals cause. The mixture now switches its function and now becomes a beneficial bacteria stimulator. Normally this dilution is 20 to 50 to 1, water to mix dilution. This diluted mix is useful in soil, creating an ideal ecological biosphere for a beneficial increase of microbial life and also for earthworms and other related life in the soil. Expanded life in the soil is a proven and effective source of carbon capture and this is in addition to the direct carbon capture originally received from the high carbon food waste and mineral mix. This invention uses a simple answer to create a solution to a massive problem.

### Alternate Possible Use #1. Recycling of Used Baby Diaper Waste:

One of the least recyclable forms of trash that waste management has to deal with is human diaper waist. Current estimates range from 3 to 7 percent of total landfill waste in the U.S. is disposable diapers. Very few diapers are recycled. An odorless and almost bacteria-free method for holding, storing and ultimately recycling this waste is needed. Not only is our proposed method for food waste adaptable for diaper recycling but this method also greatly improves the ultimate compostability of the waste. The cellulose fiber and especially the water absorbing content of the diapers could be especially beneficial to arid soil to enhance the ability of the soil to hold water. The water holding content of diapers is expensive if purchased new for direct soil enhancement especially for any large scale use. However, when available as a throw away, this re-use of this valuable discard makes recycling more practical. Some uses for some food crops may be limited due to psychological image factors, but in soils where this is not an issue this mixture could be very beneficial. The plastic parts some diapers have could be separated though shredding and segregation methods in the liquid stage and then the plastic could be available for further recycling. This mix may be made more valuable for the soil if additional carbohydrate is added to make the mix more bacteriologically active after dilution as in our other use methods. This mix would be especially valuable for use in cases where soil is damaged such as after a fire or erosion or soil that is infertile such as heavy clay or sand. Moisture held by this mix when slowly released helps overcome water shedding and erosion tendency of these soils. Diaper recycling using our carbon-capture method and system is another possible niche use to bring environmental benefits and soil enhancement.

### Alternate Possible Use #2. Fire Fighting:

A major contributor to atmospheric carbon that is exacerbated in times of warming temperatures and drought is forest fires. A tool to aid in firefighting could thus have a major impact on global carbon reserves. Forest fires often leave the land barren for many years and the amount of carbon lost to the atmosphere in forest fires is staggering. One of the physical characteristics of the sodium-removed and carbohydrate mix created in this patent use is that although the mix created is water-based, it is resilient to evaporation in its concentrated form. The mix also clings and has an oil like property that gives good coverage. This mix could be ideal to spray on as a retardant to stop the spread of active fire. The added new feature coming from this patent is that post-fire, this mix regenerates life in soil and thus this use looks forward to a more healthy forest after the fire. A downside is that in its most concentrated form, the mix can cause damage to healthy plant life so this requires the mix to be diluted with water as soon after the fire as possible. This damage is not as extensive, immediate or complete as actual fire damage and is limited to the small area of the circumference of the fire where the mix is applied as a barrier, but this is still a factor to consider especially during drought conditions where natural rainfall is not expected to do the dilution naturally. In grassland, the damage would be temporary but in forest, a small barrier line of tree loss may occur if the mix is not diluted soon after application. This damage may happen anyway as the heat of the fire often kills even when the trees are not consumed. Trees have the advantage of being deep-rooted so that even though the direct application may harm the live foliage the roots can often still regenerate. This alternative use needs much further research but is anticipated as a possible use in this patent application.

### The End of Part One

### Part Two—Customization Method of the Catalyst to Maximize Carbon Capture and Soil Benefit.

### Invention Overview Statement for Part Two

The Carbon-capture catalyst created in part one is customizable for the benefit of varying soil types, locations, or applications with an accompanying economic system for the carbon capture catalyst to be used as the unifying component of a system to accomplish carbon capture on a large scale.

### My Invention

My invention for this part of the patent is for removing atmospheric CO2 as a greenhouse gas and capturing it as part of carbon-capture agricultural activity that is improved using discovered carbon-capture catalyst properties of sodium-removed seawater mineral concentrates now modified and customized for the benefit of individual soil types, locations or applications. This invention also delivers other benefits to soil and economic benefits to those involved along with major benefits to society. This invention is a process for creating a customizable carbon-capture catalyst, the catalyst itself, and a private-sector system for utilizing and incorporating this in a new way. These all work together in synergy to enable benefits on a large scale. The process creates the customized catalyst, then the customized catalyst and method are tied together in use, function, and utility.

### The Patent Protection Sought

The process for creating the customized catalyst, the customized carbon-capture catalyst itself, and the method for using it are being presented as a single patent, although protection of the individual components; the process for creating the customizable carbon capture catalyst, the customized carbon capture catalyst itself, and the method for using it are sought. This method utilizes the catalyst, then an organization, most likely a non-profit, is enabled to bring together in a new way, resources, energy, and efforts of science, industry, farm, and consumer interests to create the promise of carbon capture on a large scale using this method. This method may hold carbon capture assets while being improved to create an enticement for early financial contributors by the realization of the increasing value of the asset over time. This also helps make the method work as early investment funds may then be available for needed public relations, brand building and funding soil improvements before any harvest benefits to the farmer occurs. This enables the whole method to begin functioning. A great obstacle is getting all parties who can potentially benefit from this process, the tools used and this proposed method aligned and working to deliver their potential contributions so the method can begin functioning. This new use of the customized carbon capture catalyst and newly invented method overcomes this problem by being a catalyst both physically (the catalyst itself) to make carbon capture more effective and economically (the method) by bringing the interests of various contributing parties together. This method provides compensations and incentives to each party involved and thus provides the potential to massively increase the amount of carbon captured in soils by specifically adding the ability to capture carbon in soils on the large scale that the method envisions.

### The Problem and Solution Overview

Atmospheric carbon-influenced climate change is believed to be a major global problem. Capturing carbon in soil from the atmosphere is not only a benefit to the soil but arguably appears to be the best solution currently available that using current technologies has the potential to offset massive amounts of carbon now being released into the atmosphere by carbon-based fuel. A problem my method overcomes is to get the energy, abilities, and financial resources of the parties who can influence the change needed to come together with those who control the land resources to make carbon capture happen on a massive scale. In the past, most effort have been to try to get farmers to do work that mostly benefits the society as a whole. This often fails. Needed is support for the farmer to then get support from the farmer. This comes together with a method to get funding, especially early funding to initiate the process. My method overcomes or moves towards overcoming these problems. The valuable carbon-capture catalyst proposed may be given to farmers and the promise of a higher financial return and higher crop yields on branded and promoted agricultural produce is a financial catalyst for gaining farmer support and making this system work.

### Advantages Over Existing Carbon Credit Systems:

Many government systems and even private systems of carbon credits have been proposed and some are even partially successful in limited cases but they all seem reliant upon government regulation and government promotion to work on the scale needed. A private method that can potentially deliver benefits to all parties involved is the subject of this patent. The invention of the customized carbon-capture catalyst is used as a tool that makes this carbon capture method workable and enables the system to deliver benefits to all of the parties needed to come together to make the method efficiently function. Benefits associated with private systems over that of government systems are often apparent. A private sector method answer that is potentially workable is the object of this patent system.

### Historical Background for Part Two of this Patent

In my book, titled Nature's Answer, I proposed the theory that the first instructions to man in the Bible, the instructions to replenish the earth, were instructions to put back into the earth what was lost and that the full spectrum of minerals from the sea contain lost mineral nutrients that need to be replenished. I am not claiming the practice of replenishing sea minerals to the soil as new art. My new use however enables a new method to do in the private sector or publicly what needs to be done to sequester carbon on a scale needed.

In practice and personal research of the theory of the importance of replenishing sea minerals to the soil for soil improvement, I made a baffling discovery that at first seemed to defy logic. I found that these soluble ionic minerals seemed to make improvements to good soil but in poor soil little difference was noticed. Since much of the soil on earth is poor soil this is a huge obstacle. The worse the soil the less difference the minerals seemed to make. This seemed counterintuitive. I could not find an answer as to why this was occurring from anyone or any source that I came across until I learned that when seeds sprout they give off tiny amounts of carbohydrate and soluble trace minerals. This started me thinking that this natural model may be the key. I developed the working theory that the trace minerals and carbohydrates together were not so much just a soil conditioner as such but rather and possibly more importantly, nutrients to create a symbiotic microbial miniature biosphere around the seed and that the reason that the trace mineral complex on its own did not benefit poor soil as much is that in poor soil the microbes are not present in levels needed to ingest the nutrients and thus hold the minerals in the soil for benefit. I believed that the soluble trace minerals simply washed away without delivering many benefits. I began experimenting with the concept of adding carbohydrates to the minerals and this seemed to be an answer as amazing results came as attested to in the pictures used in my book. At the time and on the advice of counsel I did not file for any type of patent protection on the use of sea minerals with added carbohydrates for general soil application. Either purposefully or accidentally adding carbohydrates to sea minerals for soil enhancement most likely has occurred. I attempted and failed to attract capital from large companies finding they were not interested in investment without some type of market protection. I also tried to market a one-size-fits-all single product but found that even though I had something wonderful I did not have the resources to make the marketing happen on a scale that could sustain the business in the early stages and especially to be able to make the global change needed. I developed a belief that a general use product as what is needed for a prepackaged product was good but that in practice and especially as needed for large applications a new custom-made product for each soil type and a new system for delivery and support was needed.

### The New Use, Process, and System.

Now with this as my own prior art, here is the new use, process, and system that can be used to make a carbon-capture environmental difference potentially happen on a very large scale. Simply improving soil did not generate the acceptance to attract large amounts of capital needed. The green movement however has successfully created a hunger for specific environmental answers. I had a suspicion that carbon capture in soil could specifically be more effective when combined with carbohydrate-enhanced sodium-reduced sea minerals. This was tested at my local Utah State University and I found this to be the case.

Defining the modified concentrated sea minerals as the carbon capture catalyst that it is with its ability to make other known methods of carbon capture in soil more effective and deliberately and purposely proposing its use specifically for carbon capture is a first step, then when this is combined with a method to customize the catalyst for each soil application to deliver higher efficiency and to make the method work better for most all soil types, this creates a new use and utility. The uniqueness, newness, and utility of this invention is most apparent in the prospect of the ability to accomplish carbon capture on a large scale. This very specifically adapted, customized and defined new use is beyond my own early or any general, incidental or accidental combinations of sea minerals and carbohydrates that I believe may have occurred. This is the subject of this patent application.

### Process for Creating the Customized Carbon Capture Catalyst.

Note that it is my desire to protect this process of creating the customized carbon capture tool separately by patent but the uniqueness and utility are most apparent when the process is applied to this method enabling the effect towards the desired outcome of carbon capture in various soils and for doing this on a very large scale.

### Step 1

This method and process both begin with the discovery of the carbon-capture catalyst feature and correctly identifying and labeling sodium-removed or reduced concentrated sea minerals modified with varying amounts of carbohydrate, specifically customized for each soil type as the carbon capture catalyst tool to be used. This method, when strengthened by patent protection, allows fair initiation of the new method without competition from cheaper knock-offs that are not funding the discovery, research, brand-building, and funding of the initial implementation of the system and process as a whole. Again, this is why the process and system are being presented together.

### Step 2

obtain large amounts of sodium-removed or sodium-reduced sea mineral water concentrate at near saturation concentration. This can be obtained from a variety of sources including the Great Salt Lake, the Dead Sea, underground seas, and of particular interest obtained and further concentrated and processed to remove sodium, brine obtained as a byproduct of seawater desalination. I mention the particular interest source because of the massive amounts of freshwater currently being derived from seawater and the negative sea environmental impact that may be currently occurring by releasing the heavier concentrate back into the sea where it potentially drops undiluted to the seafloor and chokes life because of its higher density. It would be far better environmentally to use this byproduct on land instead of dumping the potentially environmentally damaging byproduct into the sea.

### Step 3

Identify land where the carbon capture is to occur, then an educated evaluation is done of the soil by a soil scientist or trained technician or evaluator. This is to be used as the basis for the customization of the carbon-capture catalyst tool. Note: As data and information are obtained, kept and evaluated over time, the system will have more data to improve and perfect the customization process.

### Step 4

Using a scale of poor soil on one side and great soil (defined as full of life and microbes) on the other side, the concentrated sodium-removed sea mineral mix is customized by matching varying amounts of carbohydrates to be mixed in. This creates the customized catalyst for this soil. The amount of carbohydrate used varies usually from 20% to 200% of the sea mineral water concentrate, customized on a continuous sliding scale as a percentage of the total mix. If larger amounts of carbohydrates are available they may be used for additional carbon to be captured as this is beneficial to the carbon capture objective and not detrimental. This step maximizes the use of the carbohydrate allowing more of the carbohydrate to be available to help the poorer soils. The source of carbohydrates can vary. A mixture of blackstrap molasses works well, is readily available and inexpensive but ideally, as the system becomes more active and better able to secure sources, large amounts of food waste, food processing leftovers, and agricultural by-products or products may be obtained and become a major part of this system, thus this system will utilize the waste, keeping it from becoming pollution or a waste management issue. Poor soil as determined by step 3 (overly clay or overly sandy soil or tired soil from too much modern farming.) is customized with higher amounts of carbohydrates mixed with the sodium-removed sea minerals and the great soil can be customized with a lesser amount of carbohydrate mixed with the sodium removed concentrated sea minerals. The range of great to poor is matched along a continuous sliding scale for customization. The exception to this step is alkali soils or soils with overly high EC (electrical conductivity as a measurement for total dissolved solids). These types of soil (or compost material) initially are made worse by the addition of this carbon-capture catalyst and the core problem of the alkalinity or excessive total dissolved solids must be addressed first using soil improving techniques before proceeding with this system. This Step 4. is the critical step to making this method more universally beneficially applicable for most all soils and thus make the method a large-scale and a mostly universal answer.

### Step 5

The carbon capture catalyst is diluted with water (usually around 50 to one) in an appropriate manner so as to not cause mineral “burn” and then it is applied to the soil. This step transforms the mix from a microbe inhibitor to a microbe enhancer. In my experience ten gallons per acre of the concentrated minerals now with a varying amount of carbohydrate is used once or twice per year applied for the first, second, and up to third years, and then decreasing amounts are usually needed after that.

### Alternative Processes

### Alternative #1

The carbon capture catalyst may be added to compost or other soil amendments and then mixed with the soil. The catalyst may be added early in the composting process and is customized for a particular compost based on the amount of readily available carbohydrates in the compostable material. Mostly fibrous-high cellulose or woody compost is customized with more added carbohydrate while mostly carbohydrate compost is customized with little added carbohydrate. A sliding scale is used similarly to use as in step 4.

### Alternative #2

The carbohydrate may be grown in place, as in what is called the “green manure concept” and then the carbon capture catalyst is customized for the current soil conditions including the amount of carbohydrate now available from the “green manure” and then the customized catalyst is added as the crop is turned into the soil. The early investment money that these proposed systems provide may make this alternative more workable and affordable for farmers by paying them to do what is in the best interest of their farm and the environment instead of what is most economically expedient.

### Alternative #3

The carbon-capture catalyst may also be mixed with rock dust with favorable results using the carbohydrate mixture for the soil it is to be ultimately used in for the customization process.

### Alternative #4

Biochar may be used as a recommended carbon enhancement, but it may be best added to the soil separately and not premixed directly with the catalyst so that the catalyst does not interfere with some potential biochar benefits.

### Alternative #5

Beneficial combinations of alternative processes either separately or in combination with the original system may be used.

### Special Note

My own original, personally funded research indicates that If the carbon-capture catalyst is added early in the composting process, a significantly increased beneficial amount of retained nitrogen may also be realized in the finished compost. I found over a 400% increase in retained nitrogen in an earlier experiment study I completed at our county waste management facility. This single study may or may not be typical. This means a potential of reducing another greenhouse gas being released into the atmosphere and retaining this much needed plant growth benefit to go into the soil. This may also be a significant additional benefit and feature of this carbon capture catalyst. I expect that the retaining of nitrogen ability I observed in testing compost is also part of what this catalyst will do in the soil thus helping negate another huge environmental negative impact of modern farming, that of nitrogen leaching into lakes, streams, and oceans. As an example, currently there is a hundred-mile dead zone after the mouth of the Mississippi river into the ocean due to detrimental nitrogen leaching contamination. Similar problems exist in many other river drainage locations. The potential of increasing the nitrogen-holding ability of the carbon capture catalyst as an additional feature of the carbon-capture catalyst and method and use is as an additional benefit claim.

Part Three; an Economic Method to Maximize Use Potential of the Carbon Capture Properties of this Invention on a Massive Scale.

### Step A

This method and process both begin with the discovery of the carbon-capture catalyst feature and correctly identifying and labeling sodium-removed or reduced concentrated sea minerals modified with varying amounts of carbohydrate, specifically customized for each soil type as the carbon capture catalyst tool to be used. This method is strengthened by patent protection to allow fair initiation of the new method without competition from cheaper knock-offs that are not funding the discovery, research, brand building, and funding of the initial implementation of the whole system.

### Step B

Industry, government, and society involvement: This step is to identify and deliver benefits to early investors and obtain investment money from the sale of the carbon capture catalyst. A most difficult barrier to making carbon capture in soil happen on a massive scale is obtaining large amounts of early funding. This method delivers early benefits to companies, corporations, or other entities that have financial resources to invest and desire to benefit from “green” investment. The incentive for investment may be that by purchasing the carbon capture catalyst early and then holding this value over time while the method is increasing the value the investor may then realize the increased value of the carbon-capture catalyst as an increased-in-value tax write-off at the time it is actually donated to the farmer. This method allows companies the opportunity to be responsible to reverse some negative environmental impacts.

### Step C

Nonprofit or third-party funding from the sale of the carbon-capture catalyst: Money may be obtained early from the sale of the carbon-capture catalyst. The catalyst is increased in value over simple concentrated sea mineral brine by the activities associated with this system, then the majority of the available proceeds may be donated to a nonprofit corporation or third parties that holds the catalyst.

### Step D

Nonprofit or third party contribution: After receiving funding the work begins and continues the work of increasing the value of the carbon-capture catalyst by branding the product and building the brand through public relations, advertising, continued research and operating and publishing the results of the method to maximize impact and the carbon capture results. Connecting with farmers and landowners and enticing and encouraging them to participate in the method as well as supporting them in the method is accomplished. This is especially valuable early on to farmers by making available carbon-capture resources, providing the scientists, technicians or trained evaluators to analyze soil and prescribing the specific customization needed, and giving the potential benefits the system provides. The nonprofit may (upon making this choice available) make the donated catalyst available at no direct cash cost to farmers. It may use the donation of this valuable resource to encourage matching efforts by farmers, thus promoting the system's carbon sequestering goals. The nonprofit will administer the certification and branding of agricultural produce raised on the carbon-capture catalyst enhanced soil along with incorporating other carbon capture strategies for soil as recognized by the nonprofit.

### Step E

Consumer and public participation: This system works on the concept of very broad participation, investment, contribution, and giving an opportunity to many to help environmentally. Consumer participation is key. Consumers will have an opportunity to vote with their wallets by purchasing farm and agricultural produce branded as carbon-capture catalyst and carbon-capture system enhanced and also be able to support the companies or entities who contributed financially in the beginning. Also anticipated is the opportunity for the public to participate directly through donations by purchasing compost or other materials for farmers and thus helping to finance the gathering of compostable materials, especially the high carbohydrate or food waste materials needed to make the catalyst customizable and effective on all soil types. The public may be offered the opportunity to participate in increased tax advantages as value is added over time as the compost is completed. This consumer and public early investment would also be a huge boon to getting resources to farmers and add to the effectiveness of the system.

### Step F

Continue to run the system to benefit society and all involved in the system, reducing carbon in the atmosphere and providing all the benefits of the system.

This ends my description of my invention.

### Citations

Note that after spending many hours of searching the USPTO patent search website as well as google patent search I could not find any relative patents to what I am proposing in my patent application dealing with the words sea minerals, Great Salt Lake, Dead Sea and carbon capture in agricultural soils. I did find these mildly related patents.
Note: Since the environmental capture of carbon is a fairly recent priority the prior art should also be fairly recent.
Ferrini V, De Vito C, Mignardi S. Synthesis of nesquehonite by reaction of gaseous CO2 with Mg chloride solution: its potential role in the sequestration of carbon dioxide. J Hazard Mater. 2009 Sep. 15; 168(2-3): 832-7. doi: 10.1016/j.jhazmat.2009.02.103. Epub 2009 Feb. 26. PMID: 19303209.
CO2 Absorption and Magnesium Carbonate Precipitation in MgCl2-NH3-NH4Cl Solutions: Implications for Carbon Capture and Storage Chen Zhu 1, Han Wang 1, Gen Li 2, Siyu An 1, Xiaofeng Ding 1, Hui Henry Teng 1,3 and Liang Zhao 1,*
https://technode.global/2023/02/10/this-startup-aims-to-capture-10000-tons-carbon-from-farmland-this-year-using-volcanic-rock-dusts/
   Note: I am including the following references to rock dust from olivine and basalt rocks because like my original formulation using sea mineral concentrates and blackstrap molasses which is a high magnesium and Iron formula these rock dusts contain similar minerals.
[PDF] amazonaws.com
Carbon sequestration in olivine and basalt powder packed beds
W Xiong, R K Wells, D E Giammar—Environmental Science & . . . , 2017—ACS Publications . . . of olivine and olivine-rich rocks in conditions relevant to geologic carbon sequestration. Most experiments were done with well-mixed systems in which the olivine or basalt powders . . . SaveCiteCited by 20 Related articles All 7 versions
   [PDF] caltech.edu
Carbon sequestration on Mars
C S Edwards, B L Ehlmann-Geology, 2015-pubs.geoscienceworld.org . . . carbon sequestration potential of rocks on Mars. We find that the olivine-enriched (˜20%˜25%) basalts . . . Fe—Mg carbonate, thus limiting carbon sequestration in the Nili Fossae region to . . . Save CiteCited by 120 Related articles All 10 versions
   [PDF] cluster.is
Effect of the heterotrophic bacterium Pseudomonas reactans on olivine dissolution kinetics and implications for CO2 storage in basalts
L S Shirokova, P Bénézeth, O S Pokrovsky . . . et Cosmochimica Acta, 2012—Elsevier . . . Olivine dissolution rate as a function of pH measured at 25 C in batch experiments in this study (duplicates, 5-10 sampling for each rate), at 30 atm pCO 2 (two duplicates, 15-20 . . . . Save Cite Cited by 51 Related articles All 8 versions
Olivine reactivity with CO2 and H2O on a microscale: Implications for carbon sequestration
J Olsson, N Bovet, E Makovicky, K Bechgaard . . . et Cosmochimica Acta, 2012—Elsevier . . . Olivine is a good candidate for CO2 sequestration because: (1) it is present in basalt, which . . . and the highest capacity for carbon capture; (3) olivine does not contain aluminum, which . . . SaveCiteCited by 71 Related articles All 7 versions.
   [PDF] sciencedirect.com
Effectiveness of enhanced mineral weathering as a carbon sequestration tool and alternative to agricultural lime: an incubation experiment
C Dietzen, R Harrison, S Michelsen-Correa—International Journal of . . . , 2018—Elsevier . . . suggest that olivine amendments are an effective tool for carbon . . . olivine-rich basalt, may work well as a more widely available alternative. Though the carbon capture potential of basalt . . . SaveCiteCited by 42 Related articles All 4 versions
   [PDF] wiley.com
Increased yield and CO2 sequestration potential with the C₄ cereal Sorghum bicolor cultivated in basaltic rock dust-amended agricultural soil
M E Kelland, P W Wade, A L Lewis . . . Global Change . . . , 2020—Wiley Online Library . . . Mg is present in the most reactive components of our basalt (olivine and diopside; Table 1) and is less affected by plant uptake (FIG. 2) and secondary mineral precipitation than Ca . . . SaveCiteCited by 87 Related articles All 12 versions
   [HTML] frontiersin.org
[HTML] Enhanced weathering using basalt rock powder: carbon sequestration, co-benefits and risks in a mesocosm study with Solanum tuberosum
A Vienne, S Poblador, M Portillo-Estrada . . . Frontiers in . . . , 2022—frontiersin.org . . . olivine within basalt, we expect Ni in pore water to decrease over time. Information about initial soil Ni . . . provide a theoretical maximum on the amount of basalt that can be applied. In our . . . Save Cite Cited by 12 Related articles All 6 versions
   [PDF] sciencedirect.com
Permanent carbon dioxide storage into basalt: the CarbFix pilot project, Iceland.
J M Matter, W S Broecker, M Stute, SR Gislason . . . Energy Procedia, 2009—Elsevier . . . Up to date, the potential of CO2 storage in basaltic rocks have been demonstrated on a limited scale. In an . . . Crystalline basalt is rich in plagioclase feldspars, pyroxene and olivine, and . . . SaveCiteCited by 139 Related articles All 14 versions
   [HTML] nature.com
   Full View
[HTML] Transformation of abundant magnesium silicate minerals for enhanced CO₂ sequestration
A Scott, C Oze, V Shah, N Yang, B Shanks . . . Earth & Environment, 2021—nature.com . . . We would like to note that although olivine was assessed and used in this study, its . . . from basalt; however, we will primarily focus our discussion on two enriched and accessible olivine . . .

1. My invention claim is that sodium-reduced sea mineral concentrates used as a stabilizing base to capture and preserve food waste carbon or other organic carbon sources rendering the carbon mixture more bacteriologically inert, odor free, vermin repellent and microbe stable to hold for later use, and then when diluted before use this combination of Carbohydrates, fiber, and other caloric food waste, combined with the concentrated, sodium-removed sea minerals becomes a soil life enhancer with newly discovered catalyst properties for greater carbon sequestering in soil than the properties of the components individually and separately alone and this is a new invention.

2. This invention according to claim 1 has proposed beneficial end-uses that makes this gathering of food waste more valuable and thus the system is more economical.

3. This invention according to claim 1 can become also a direct soil enhancement as an addition to soil

4. This invention according to claim 1 can be used as a composting aid.

5. This invention according to claim 1 is important because it opens the door for millions of tons of waste food to be recycled in a way that may help revitalize the agricultural economic sector, while having a very positive environmental impact and carbon sequestering effect.

6. This invention according to claim 1 makes Discarded food and carbohydrate nutrients that exist as a major pollution and refuse problem to become a major benefit when used according to this patent.

7. This invention according to claim 1 makes the saving of food waste a private sector priority through the creation of a more valuable end-use product and thus makes this invention an eloquent solution to overcoming the smell, vermin, health hazards and storage of food waste.

8. This invention according to claim 1 allows more waste to be recycled because of more flexible circumstances requiring less care and reducing the expense of rapid transport and processing currently required in dealing with fresh waste refuse.

9. This invention method claims that it can produce a customizable product for higher carbon sequestering activity for each soil type made possible by the discovery that poor soils require more carbohydrate in the mix than prime and microbially alive soils to deliver the optimized carbon sequestering effect.

10. My invention claim is that it's methods can be used to benefit non-profit companies, investors, farmers, land owners, society and government interests, under patent protection, facilitated by carbon sequestering on a massive scale that is made possible by the discovery that food waste carbon is stabilized using sodium reduced sea minerals combined with the soil carbon sequestering catalytic effect (independent claim number one and independent claims) along and the potential to customize the system for each soil type (independent claim number two) which enables methods for economic benefits.

11. This invention according to claim 10 uses these methods to hold carbon capture assets while being improved and increased in value over time to create an enticement for early financial contributors by the realization of the increasing value of the asset over time.

12. This invention according to claim 10 uses these methods to be able to attract early investment funds and thus may be able to secure funds as needed for public relations, brand building and funding soil improvements before any harvest benefits to the farmer occurs enabling these whole methods to begin functioning and getting all parties who can potentially benefit from these methods aligned and working to deliver their potential contributions so the methods can function.

13. This invention according to claim 10 uses these methods to get the energy, abilities, and financial resources of parties who can influence change needed, to come together with those who control the land resources to make carbon capture happen on a massive scale.

14. This invention according to claim 10 Defines the concentrated sea minerals with a carbohydrate source as the carbon capture catalyst that it is and deliberately and purposely proposes its use specifically for carbon capture as a benefit to helping get the totality of these methods to work together.

15. This invention according to claim 10 uses the discovered nitrogen-holding ability of the carbon capture catalyst in soil and compost as an additional claimed beneficial feature.

16. This invention according to claim 10 uses these methods to allow participating organizations the opportunity to claim to be responsible to reverse some negative environmental impacts.

17. This invention according to claim 10 uses certification and branding of agricultural produce using these methods as a claimed benefit.

18. This invention according to claim 10 allows entities the opportunity to participate in tax advantages as a benefit of this method as value is added over time as the compost is completed or the minerals are increased in value through these methods.
